(19) United States
(12) Patent Application Publication
(10) Pub. No.: US 2012/0154529 A1
(43) Pub. Date: Jun. 21, 2012

(54) Stereoscopic Video Signal Processing Apparatus and Method Therefor

(76) Inventor: Takero Kobayashi, Akishima-shi (JP)

(21) Appl. No.: 13/183,244

(22) Filed: Jul. 14, 2011

(30) Foreign Application Priority Data
Dec. 20, 2010 (JP) 2010-283208

(51) Int. Cl. H04N 13/00

(52) U.S. Cl. 348/43; 348/E13.001

(57) ABSTRACT

According to one embodiment, a basic format having a first area to arrange main video data, a second area to arrange graphic data, a third area to arrange control information of pixels of the graphic data, and a fourth area to arrange control information of pixels of the main video data are defined. A distribution module distributes a first plane containing data in the first area and the second area and a second plane containing data in the third area and the fourth area. A first image quality adjustment module makes image quality adjustments of the data of the first plane. A combination module combines data of the second plane with the data of the first plane whose image quality has been adjusted.

### CROSS-REFERENCE TO RELATED APPLICATIONS

This application is based upon and claims the benefit of priority from Japanese Patent Application No. 2010-283208, filed Dec. 20, 2010; the entire contents of which are incorporated herein by reference.

### FIELD

Embodiments described herein relate generally to a stereoscopic video signal processing apparatus and a method therefor.

### BACKGROUND

Stereoscopic video display technology of a glasses-less type capable of perceiving stereoscopic video without using special glasses can be classified in various ways. Such stereoscopic video display technology is generally classified into a binocular parallax method using a binocular parallax and a spatial image reproducing method that actually forms a spatial image.

The binocular parallax method is further classified into a twin type and a multi type. The twin type is a method by which an image for the left eye and an image for the right eye are made visible by the left eye and the right eye, respectively. The multi type is a method by which a range in which stereoscopic video is observable is broadened by using a plurality of observation positions when a video is shot to increase the amount of information.

The spatial image reproducing method is further classified into a holograph method and an integral photography method (hereinafter, called the integral method, but may also be called a ray reproducing method). The integral method may be classified as the binocular parallax method. According to the integral method, rays take quite opposite paths between shooting and reproducing video and thus, almost complete stereoscopic video is reproduced if the number of rays is made sufficiently large and the pixel size can be made sufficiently small. Thus, the ideal integral method is classified as the spatial image reproducing method.

Incidentally, to perceive stereoscopic video without glasses as in the multi type and the integral method, the configuration described below is normally adopted. A stereoscopic video display pixel arrangement is configured on a two-dimensional image display pixel arrangement. A mask (also called a ray control element) having a function to control rays from stereoscopic video display pixels is arranged on a front face side of the stereoscopic video display pixel arrangement. The mask is provided with window portions far smaller than stereoscopic video display pixels (typically as small as two-dimensional image display pixels) in positions corresponding to stereoscopic video display pixels.

A fly eye lens in which micro-lenses are arranged two-dimensionally, a lenticular seat in a shape in which optical openings extend linearly in the vertical direction and are periodically arranged in the horizontal direction, or slits are used as the mask.

According to such a configuration, element images displayed by individual stereoscopic video display pixels are partially blocked by the mask so that an observer visually recognizes only element images that have passed through window portions. Therefore, two-dimensional image display pixels visually recognized via some window portion can be made different from observation position to observation position so that stereoscopic video can be perceived without glasses.

As described above, a basic configuration of an apparatus to display stereoscopic video has been embodied. A stereoscopic video signal is needed to display the stereoscopic video. Various techniques have been developed as methods to obtain a stereoscopic video signal. To obtain a stereoscopic video signal, a method of using a plurality of imaging apparatuses placed at intervals in the horizontal direction to obtain video signals with different visual angles (different parallaxes) from each of the imaging apparatuses is known. Also, a method of obtaining a stereoscopic video signal by processing a two-dimensional (2D) video signal is known. However, a conventional signal processing apparatus has many problems to offer convenience as a product.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing a representative outline of a stereoscopic video display apparatus according to an embodiment;

FIG. 2 is an exemplary view showing a representative configuration example of a 3D processing module;

FIG. 3 is an exemplary view showing an example of progress of representative signal processing by the 3D processing module;

FIG. 4 is an exemplary view showing a representative internal configuration example of the 3D processing module in FIG. 3; and

FIG. 5 is an exemplary view showing a representative overall configuration example of a TV set with which the stereoscopic video display apparatus is integrated.

### DETAILED DESCRIPTION

Various embodiments will be described hereinafter with reference to the accompanying drawings.

In general, according to one embodiment, there are provided a stereoscopic video signal processing apparatus and a method therefore that provide excellent image quality by devising a processing route of data of a basic format to obtain stereoscopic video and can adapt to various kinds of stereoscopic video signal processing.

According to an embodiment of the present disclosure, a basic format having a first area to arrange main video data, a second area to arrange graphic data, a third area to arrange control information of pixels of the graphic data, and a fourth area to arrange control information of pixels of the main video data is defined. A distribution module distributes a first plane containing data in the first area and the second area and a second plane containing data in the third area and the fourth area in the basic format. A first image quality adjustment module makes image quality adjustments of the data of the first plane. A combination module combines data of the second plane with the data of the first plane whose image quality has been adjusted.

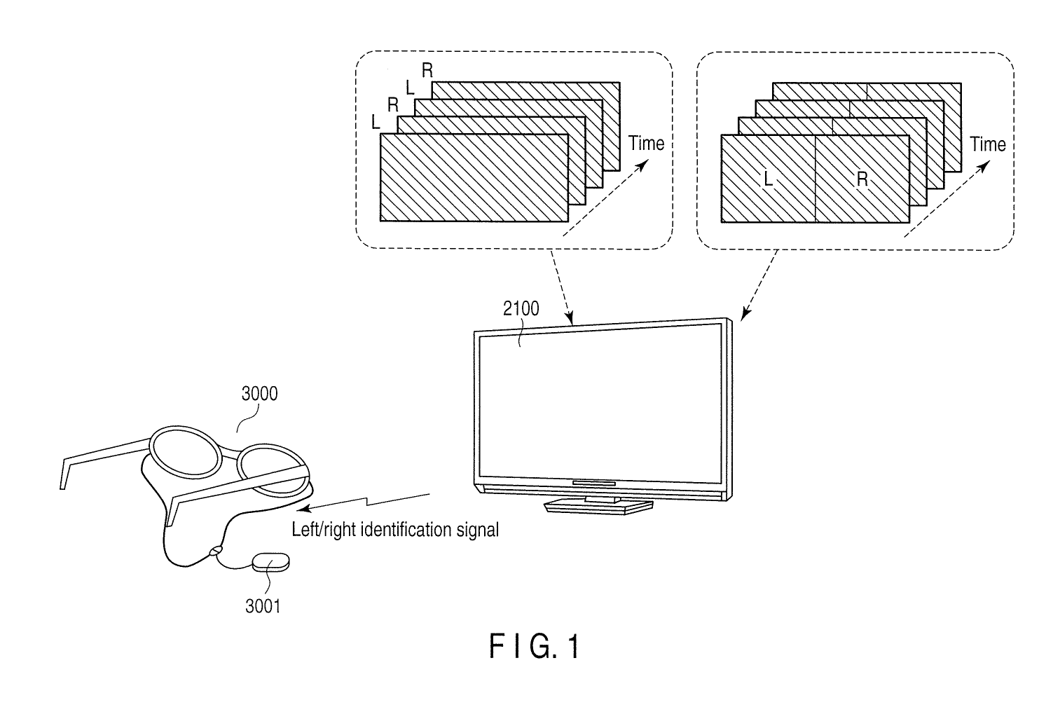

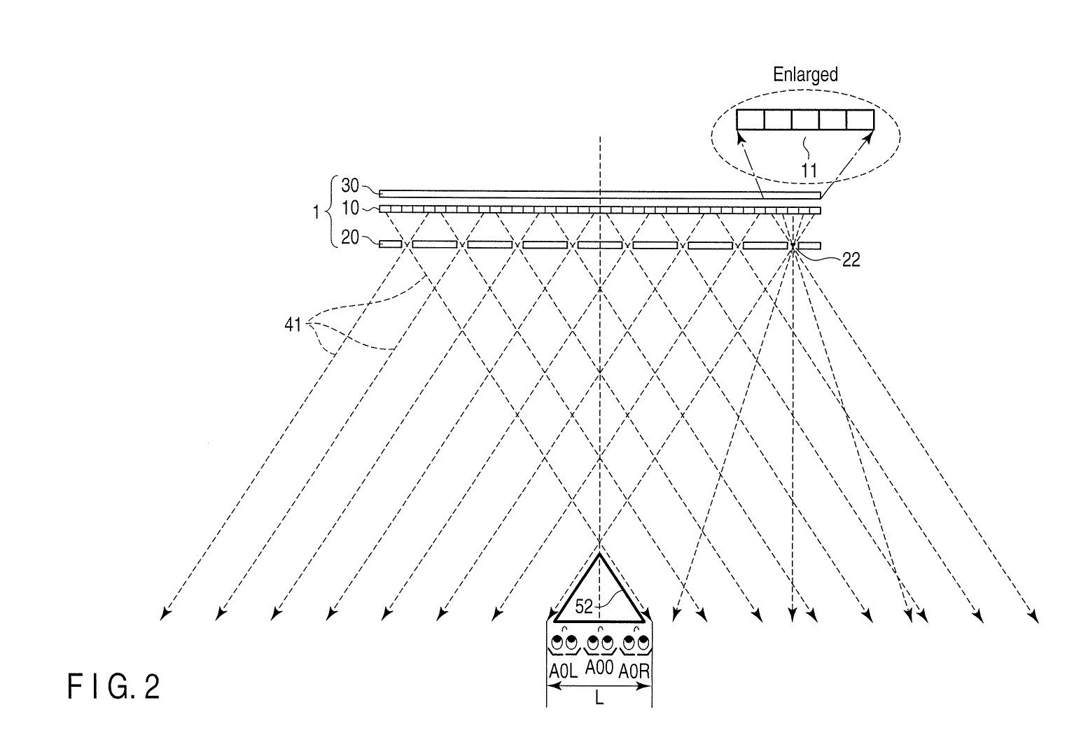

An embodiment will further be described with reference to the drawings. First, the principle of a stereoscopic video display will be described. FIG. 1 is an example of a stereoscopic video display apparatus of the twin type in which stereoscopic video can be observed by using glasses, and FIG. 2 is an example of a stereoscopic video display apparatus of the glasses-less type in which stereoscopic video can be observed without glasses.

In FIG. 1, two twin types are shown simultaneously.

The first type is an example in which a left eye video (L) and a right eye video (R) are alternately displayed for each frame in a TV set 2100. A signal of the left eye video (L) and a signal of the right eye video (R) may be either sent from outside or generated as a dummy signal from a 2D display video signal inside the TV set.

Identification information indicating which of the left eye video and the right eye video is the currently displayed video is output from the TV set 2100. A transfer medium of left/right identification information may be a wire, radio wave, or infrared ray. 3D glasses 3000 have a receiver 3001, which receives identification information and controls a shutter operation of left and right liquid crystal glasses to synchronize the shutter operation to the displayed left/right video. Accordingly, a viewer can perceive stereoscopic video by observing the right eye video with the right eye and the left eye video with the left eye.

The second type is an example in which the left eye video (L) arranged in a left half of a frame and the right eye video (R) arranged in a right half of the frame are displayed in the TV set 2100. Also, a signal of the left eye video (L) and a signal of the right eye video (R) may be either sent from outside or generated as a dummy signal from a 2D display video signal inside the TV set. This method may be called a side-by-side method. Outgoing light by left video and outgoing light by right video are different in polarization direction and polarizing glasses are used as the 3D glasses 3000. Left and right glasses have polarization properties, the left glass allows the left video to pass, and the right glass allows the right video to pass. Accordingly, the viewer can perceive stereoscopic video by observing the right eye video with the right eye and the left eye video with the left eye. Further, various other stereoscopic video display methods are known, but a description thereof is omitted.

A stereoscopic video display apparatus 1 shown in FIG. 2 is of the glasses-less type and includes a display unit 10 including many stereoscopic video display pixels 11 arranged horizontally and vertically and a mask 20 separated from the stereoscopic video display pixels 11 and provided with many window portions 22 corresponding to the stereoscopic video display pixels 11.

The mask 20 includes optical openings and has a function to control rays from the pixels. The mask 20 is also called a parallax barrier or ray control element. A transparent substrate having formed thereon a light-shielding body pattern with many openings corresponding to the many window portions 22 or a light-shielding plate provided with many through-holes corresponding to the many window portions 22 can be used as the mask 20. Alternatively, a fly eye lens in which many micro-lenses are arranged two-dimensionally or a lenticular seat in a shape in which optical openings extend linearly in the vertical direction and are periodically arranged in the horizontal direction can also be used as other examples of the mask 20. Further, a transmission type liquid crystal display unit in which the arrangement, dimensions, shape and the like of the window portion 22 are freely changeable can be used as the mask 20.

For stereoscopic vision of a still image, the stereoscopic video display pixels 11 may be paper on which an image is printed. However, for stereoscopic vision of dynamic images, the stereoscopic video display pixels 11 are realized by using a liquid crystal display unit. Many pixels of the transmission type liquid crystal display unit 10 constitute the many stereoscopic video display pixels 11 and a backlight 30 serving as a surface light source is arranged on the back face side of the liquid crystal display unit 10. The mask 20 is arranged on the front face side of the liquid crystal display unit 10.

When the transmission type liquid crystal display unit 10 is used, the mask 20 may be arranged between the backlight 30 and the liquid crystal display unit 10. Instead of the liquid crystal display unit 10 and the backlight 30, a self-light emitting display apparatus such as an organic EL (electro-luminescence) display apparatus, cathode ray tube, and plasma display apparatus may be used. In such a case, the mask 20 is arranged on the front face side of the self-light emitting display apparatus.

FIG. 2 schematically shows a relationship between the stereoscopic video display apparatus 1 and observation positions A00, A0R, and A0L.

The observation position is a position after moving in a horizontal direction of a display screen while maintaining the distance to the screen (or the mask) constant. This example shows a case where one stereoscopic video display pixel 11 is constituted of a plurality of (for example, five) two-dimensional display pixels. The number of pixels is only an example and may be less than five (for example, two) or more (for example, nine).

In FIG. 2, a broken line 41 is a straight line (ray) linking the center of a single pixel positioned in the boundary between the adjacent stereoscopic video display pixels 11 and the window portion 22 of the mask 20. In FIG. 2, an area of a thick line 52 is an area in which true stereoscopic video (original stereoscopic video) is perceived. The observation positions A00, A0R, and A0L are positioned within the area of the thick lines 52. An observation position in which only true stereoscopic video is perceived will be called a “viewing area” below.

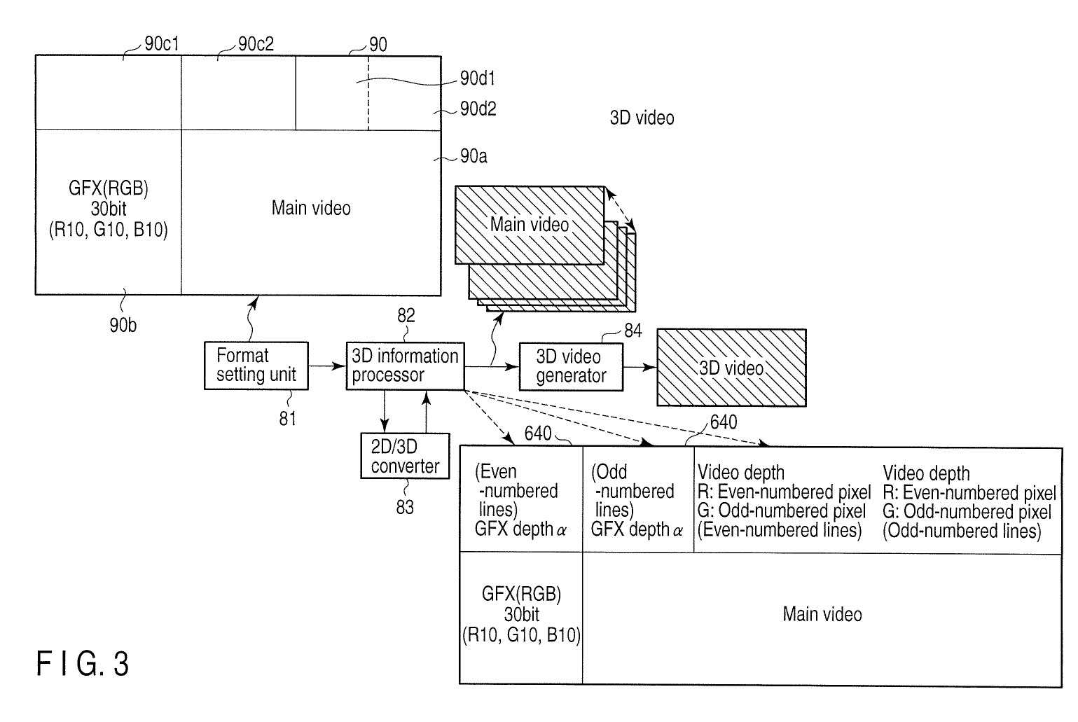

FIG. 3 shows an example of a 3D processing module 80 that converts a 2D video display signal into a 3D video display signal. The 3D processing module 80 receives a twin 3D video display signal in which, for example, a 2D video display signal for the left eye is arranged in a left area and a 2D video display signal for the right eye is arranged in a right area.

The 3D processing module 80 converts one of 2D video display signals of a twin 3D video display signal into a glasses-less type 3D video display signal. That is, the 3D processing module 80 forms a 2D video display signal into a 3D signal format. If a 3D signal is input, the signal can be adopted unchanged. The 3D signal format can contain a 2D digital input video signal (main video data) and graphics such as OSD and other data simultaneously.

After being 3D-formatted by a format setting unit 81, the 2D digital input video signal is input into a 3D information processor 82. The 3D information processor 82 extracts main video data and sends the extracted video data to a 2D/3D converter 83. The 2D/3D converter 83 generates depth information (this information, which may also be called length information, is assumed to contain parallax information) for each pixel of the main video data. The 3D information processor 82 uses information of the 3D signal format generated by the format setting unit 81 and the depth information of the main video data generated by the 2D/3D converter 83 to generate a plurality of (for example, nine) video planes for 3D configuration. The depth information for each pixel of graphic data may be preset to the format setting unit 81.

The plurality of video planes for 3D configuration and the depth information are input into a 3D video generator 84 for conversion into a 3D video display signal (stereoscopic video display signal). The 3D video display signal becomes a pattern signal that drives stereoscopic video display pixels shown in FIG. 3.

The 3D signal format includes an area 90a to arrange main video data, an area 90b to arrange graphic data (including R, G, and B pixels), an area 90c1 to arrange depth information of pixels of even-numbered lines of the graphic data and an α value, an area 90c2 to arrange depth information of pixels of odd-numbered lines of the graphic data, an area 90d1 to arrange depth information of pixels of even-numbered lines of the main video data and the a value, and an area 90d2 to arrange depth information of pixels of odd-numbered lines of the main video data. Depth information of pixels of the main video data contains depth information about even-numbered pixels and odd-numbered pixels. The α value is a value indicating the degree of overlapping with pixels of graphic data.

The area 90a of main video data has, for example, 1280 pixels×720 lines, the area 90b has 640 pixels×720 lines, the area 90c1 has 640 pixels×360 lines, the area 90c2 has 640 pixels×360 lines, the area 90d1 has 320 pixels×360 lines, and the area 90d2 has 320 pixels×360 lines.

The other areas 90c1, 90c2, 90d1, 90d2 than the areas 90a, 90b of main video data and graphic data may be called control information areas. Control information is generated by the 3D information processor 82 and the 2D/3D converter 83 and arranged in predetermined areas.

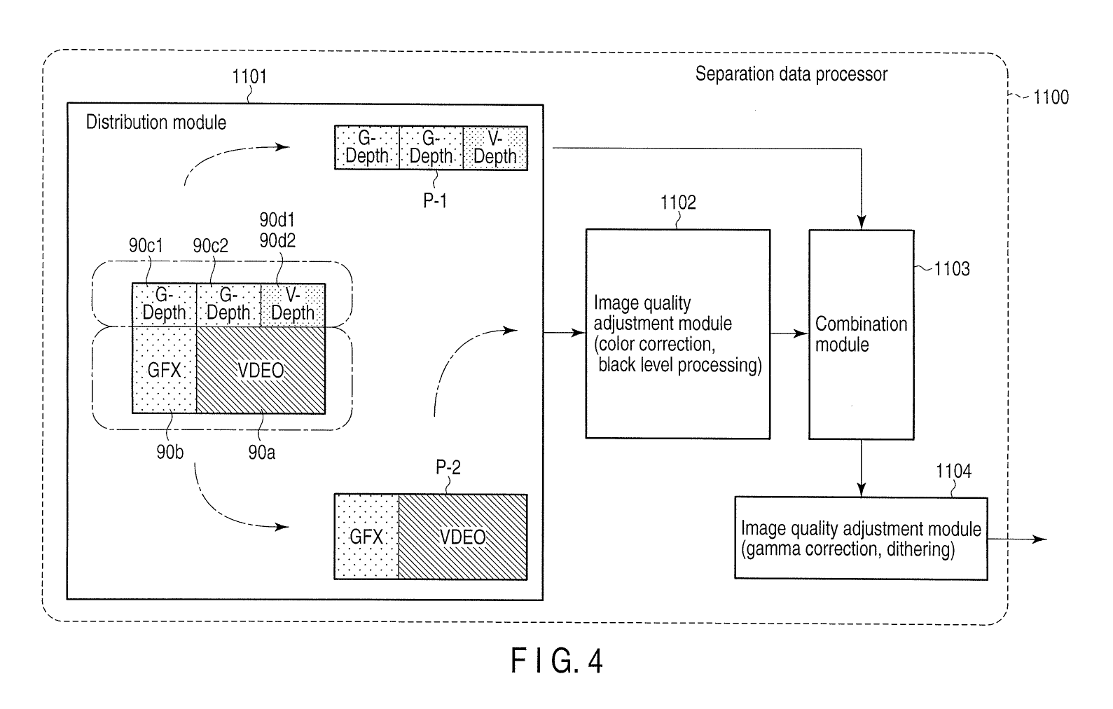

FIG. 4 shows, for example, a configuration example of a separation data processor 1100 provided in an output stage of the 3D information processor 82. The separation data processor 1100 includes a distribution module 1101, a first image quality adjustment module 1102, a combination module 1103, and a second image quality adjustment module 1104.

In the present embodiment, the basic format for a 3D signal is defined and a first area 90a to arrange main video data, a second area 90b to arrange graphic data, third areas 90c1, 90c2 to arrange depth information of pixels of the graphic data, and fourth areas 90d1, 90d2 to arrange depth information of pixels of the main video data are provided.

The distribution module 1101 separates a first plane P-1 containing the first area and the second area and a second plane P-2 containing the third area and the fourth area from the basic format. Then, the distribution module 1101 transmits the first plane P-1 to the first image quality adjustment module 1102 and the second plane P-2 to the combination module 1103.

The first image quality adjustment module 1102 makes image quality adjustments such as the color adjustment and black level adjustment on the first plane P-1. Data of the first plane P-1 after image quality adjustments being made is input into the combination module 1103. In the combination module 1103, the first plane P-1 and the second plane P-2 are combined to reconstruct the basic format. Output of the combination module 1103 is transmitted to the second image quality adjustment module 1104 (or the 3D video generator 84 in FIG. 3) where the gamma correction, dithering and the like are performed thereon as a 3D signal.

In the above description, FIGS. 3 and 4 have been described as the 3D processing module 80 that converts a 2D video display signal into a 3D video display signal. However, a complete version of 3D video display signal shown in FIG. 3 (data already arranged in each area) may be input from outside. The present embodiment includes processing in such a case as the first plane and the second plane described in FIG. 4 by breaking down a signal in necessary areas. Moreover, a signal in each area may be input independently. In such a case, the first and second planes P-1, P-2 described above can be constructed by selecting signals. Therefore, the present embodiment can flexibly handle input 3D signals of different methods. If, for example, a signal by the side-by-side method is input, a frame of one side can be used. If video for the left eye and video for the right eye are alternately input for each frame, only the frame of one side may be adopted.

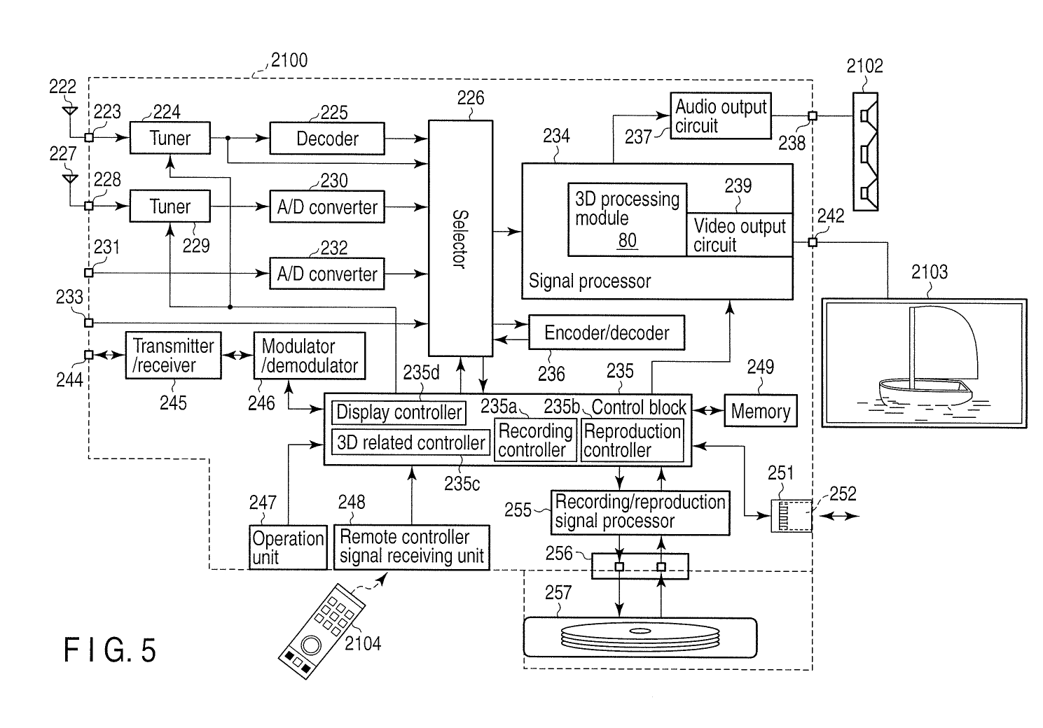

FIG. 5 schematically shows a signal processing system of the TV set 2100, which is an example of an apparatus to which the embodiment is applied. A digital TV broadcasting signal received by an antenna 222 for receiving digital TV broadcasting is supplied to a tuner 224 via an input terminal 223. The tuner 224 tunes in to and demodulates a signal of the desired channel from the input digital TV broadcasting signal. A signal output from the tuner 224 is supplied to a decoder 225 where decode processing according to, for example, the MPEG (moving picture experts group) 2 method is performed before being supplied to a selector 226.

Output from the tuner 224 is also supplied to the selector 226 directly. Video/audio information is separated by the selector 226 so that the video/audio information can be processed by a recording/reproduction signal processor 255 via a control block 235. A signal processed by the recording/reproduction signal processor 255 can be recorded in a hard disk drive (HDD) 257. The HDD 257 is connected as a unit to the recording/reproduction signal processor 255 via a terminal 256 and can be replaced. The HDD 257 contains a recorder and a reader of a signal.

An analog TV broadcasting signal received by an antenna 227 for analog TV broadcasting is supplied to a tuner 229 via an input terminal 228. The tuner 229 tunes in to and demodulates a signal of the desired channel from the input analog TV broadcasting signal. Then, a signal output from the tuner 229 is digitized by an A/D (analog/digital) converter 230 before being output to the selector 226.

Analog video and audio signals supplied to an input terminal 231 for an analog signal to which, for example, devices such as a VTR are connected are supplied to an A/D converter 232 for digitalization and then output to the selector 226. Further, digital video and audio signals supplied to an input terminal 233 for a digital signal connected to an external device such as an optical disk or magnetic recording medium reproduction apparatus via, for example, HDMI (High Definition Multimedia Interface) are supplied to the selector 226 unchanged.

When an A/D converted signal is recorded in the HDD 257, compression processing based on a predetermined format, for example, the MPEG (moving picture experts group) 2 method is performed on the A/D converted signal by an encoder in an encoder/decoder 236 accompanying the selector 226 before the A/D converted signal is recorded in the HDD 257 via the recording/reproduction signal processor 255. When the recording/reproduction signal processor 255 records information in the HDD 257 in cooperation with a recording controller 235a, for example, what kind of information to record in which directory of the HDD 257 is pre-programmed. Thus, conditions when a stream file is stored in a stream directory and conditions when identification information is stored in a recording list file are set.

The selector 226 selects one pair from four types of input digital video and audio signals to supply the pair to a signal processor 234. The signal processor 234 separates audio information and video information from the input digital video signal and performs predetermined signal processing thereon.

Audio decoding, tone adjustment, mix processing and the like are arbitrarily performed as the signal processing on the audio information. Color/brightness separation processing, color adjustment processing, image quality adjustment processing and the like are performed on the video information.

The 3D processing module 80 described above is contained in the signal processor 234. A video output unit 239 switches to 3D signal output or 2D signal output in accordance with 3D/2D switching. The video output unit 239 includes a synthesis unit that multiplexes graphic video, video of characters, figures, symbols and the like, user interface video, video of a program guide and the like from the control block 235 onto main video. The video output unit 239 may contain a scanning line number conversion.

Audio information is converted into an analog form by an audio output circuit 237 and the volume, channel balance and the like thereof are adjusted before being output to a speaker apparatus 2102 via an output terminal 238.

Video information undergoes synthesis processing of pixels, the scanning line number conversion and the like in the video output unit 239 before being output to a display apparatus 2103 via an output terminal 242. As the display apparatus 2103, for example, the apparatus described in FIG. 2 is adopted.

Various kinds of operations including various receiving operations of the TV set 2100 are controlled by the control block 235 in a unified manner. The control block 235 is a set of microprocessors incorporating CPUs (central processing units). The control block 235 controls each of various blocks so that operation information from an operation unit 247 or operation information transmitted from a remote controller 2104 is acquired by a remote controller signal receiving unit 248 whereby operation content thereof is reflected.

The control block 235 uses a memory 249. The memory 249 mainly includes a ROM (read only memory) storing a control program executed by a CPU thereof, a RAM (random access memory) to provide a work area to the CPU, a nonvolatile memory in which various kinds of setting information and control information are stored.

The apparatus can perform communication with an external server via the Internet. A downstream signal from a connection terminal 244 is demodulated by transmitter/receiver 245 and demodulated by a modulator/demodulator 246 before being input into the control block 235. An upstream signal is modulated by the modulator/demodulator 246 and converted into a transmission signal by the transmitter/receiver 245 before being output to the connection terminal 244.

The control block 235 can perform conversion processing on dynamic images or service information downloaded from an external server to supply the converted images or information to the video output unit 239. The control block 235 can also transmit a service request signal to an external server in response to a remote controller operation.

Further, the control block 235 can read data in a card type memory 252 mounted on a connector 251. Thus, the present apparatus can read, for example, photo image data from the card type memory 252 to display the photo image data in the display apparatus 2103. When special color adjustments are made, image data from the card type memory 252 can be used as standard data or reference data.

In the above apparatus, a user views a desired program of a digital TV broadcasting signal and also selects a program by operating the remote controller 2104 to control the tuner 224 if the user wants to save the program in the HDD 257.

Output of the tuner 224 is decoded by the decoder 225 into a base-band video signal and the base-band video signal is input into the signal processor 234 from the selector 226. Accordingly, the user can view the desired program in the display apparatus 2103.

A stream (including many packets) of the selected program is input into the control block 235 via the selector 226. If the user performs a recording operation, the recording controller 235a selects the stream of the program and supplies the stream to the recording/reproduction signal processor 255. For example, a file number is attached to the stream of the selected program and the stream is stored in a file directory of the HDD 257 as a stream file by the operations of the recording controller 235a and the recording/reproduction signal processor 255.

If the user wants to reproduce and view the stream file recorded in the HDD 257, the user operates, for example, the remote controller 2104 to specify the display of, for example, a recording list file.

The recording list file has a table of a file number and a file name (called identification information) indicating what kinds of stream files are recorded in the HDD 257. If the user specifies the display of the recording list file, a recording list is displayed as a menu and the user moves the cursor to a desired program name or file number in the displayed list before operating the Decision button. Then, the reproduction of the desired stream file is started.

The specified stream file is read from the HDD 257 under the control of a reproduction controller 235b and decoded by the recording/reproduction signal processor 255 before being input into the signal processor 234 via the control block 235 and the selector 226.

The control block 235 includes a recording controller 235a, a reproduction controller 235b, and a 3D related controller 235c.

After receiving an operation signal from, for example, a remote controller 2104, the 3D related controller 235c can provide an image quality adjustment control signal to the image quality adjustment module 1102 in the 3D processing module 80. Accordingly, adjustment parameters in the image quality adjustment module 1102 are changed so that the color adjustment level and black level correction level can be varied.

The above embodiment provides excellent image quality by devising display data and a processing route of display control data to stereoscopically render the display data and can adapt to various kinds of stereoscopic video signal processing.

If first image quality adjustments are made while data is present in the first to fourth areas of the basic format, control information (depth information) deviates so that the 3D image generator generates an unexpected 3D video display signal, which could deteriorate 3D video quality. According to the present embodiment, however, such deterioration of 3D video is prevented.

In the above embodiments, the module is used as a name of some blocks. However, the module is not limited in the scope of the invention. It may be used block, unit, processor, circuit and combination of these terms instead of the module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic video signal processing apparatus, wherein
a basic format having a first area to arrange main video data, a second area to arrange graphic data, a third area to arrange control information of pixels of the graphic data, and a fourth area to arrange the control information of pixels of the main video data is defined, comprising:
a distribution module configured to distribute a first plane containing data of the first area and the second area and a second plane containing the data of the third area and the fourth area in the data of the basic format;
a first image quality adjustment module configured to make image quality adjustment of the data of the first plane; and
a combination module configured to combine the data of the second plane with the data of the first plane whose image quality has been adjusted.

2. The stereoscopic video signal processing apparatus of claim 1, wherein the control information in the third area is depth information of pixels of the graphic data and the control information in the fourth area is depth information of pixels of the main video data.

3. The stereoscopic video signal processing apparatus of claim 1, wherein the control information in the third area is alpha value information used for superposition of pixels of the graphic data.

4. The stereoscopic video signal processing apparatus of claim 2, further comprising a second image quality adjustment module configured to make adjustments including a gamma adjustment and dither adjustment after the data is input from the combination module.

5. The stereoscopic video signal processing apparatus of claim 4, wherein the first image quality adjustment module has adjustment parameters changed by a control signal from a control block based on an operation.

6. A stereoscopic video signal processing method by a 3D signal processing module and a 3D related controller that outputs a control signal of the 3D signal processing module, wherein
a basic format for a 3D signal having a first area to arrange main video data, a second area to arrange graphic data, a third area to arrange depth information of pixels of the main video data, and a fourth area to arrange depth information of pixels of the graphic data is defined, comprising:
distributing a first plane containing data of the first area and the second area and a second plane containing the data of the third area and the fourth area in the data of the basic format by the 3D signal processing module;
making image quality adjustment of the data of the distributed first plane; and
combining the data of the second plane with the data of the first plane whose image quality has been adjusted.

7. The stereoscopic video signal processing method of claim 6, wherein control information in the third area is the depth information of pixels of the graphic data and control information in the fourth area is the depth information of pixels of the main video data.

8. The stereoscopic video signal processing method of claim 7, wherein adjustments including gamma adjustment and dither adjustment are made on output data after the combination.

9. The stereoscopic video signal processing method of claim 8, wherein adjustment parameters are changed by a control signal from a control block based on an operation in image quality adjustments including color adjustment and black level adjustment.
